(19) United States
(12) Patent Application Publication
(10) Pub. No.: US 2024/0403656 A1
(43) Pub. Date: Dec. 5, 2024

(54) APPARATUS AND METHOD FOR DATA LEARNING SYSTEM BASED ON A SECURED MODELING EXCHANGE

(71) Applicant: NTT DOCOMO, INC., Tokyo (JP)

(72) Inventors: Hiroki Moriya, Sunnyvale, CA (US); Yoshitaka Inoue, Sunnyvale, CA (US)

(21) Appl. No.: 18/597,648

(22) Filed: Mar. 6, 2024

Related U.S. Application Data
(60) Provisional application No. 63/470,108, filed on May 31, 2023.

(51) Int. Cl. G06N 3/098

(52) U.S. Cl. CPC G06N 3/098

(57) ABSTRACT

Architectures, apparatuses and methods for building data learning systems (e.g., machine learning (ML) systems, etc.). In some embodiments, an architecture to build a global machine learning (ML) model includes a platform to identify a group of clients to build a global model by federated learning. In some embodiments, the platform includes a group manager to build the global model by supplying a model definition for the global model to the group and aggregating model parameters received from the group to build the global model, the model parameters being generated by the clients training a local ML model at their respective client sites using local data at their respective client sites; and an incentive calculator communicably coupled to the group manager to calculate an incentive to each client communicably coupled to the platform based on said each client's contribution to train the global model, each client's contribution including one or more model parameters generated as a result of training their local ML model with local data.

### RELATED APPLICATION

The present application is a non-provisional application of and claims the benefit of U.S. Provisional Patent Application No. 63/470,108, filed May 31, 2023, and entitled “APPARATUS AND METHOD FOR DATA LEARNING SYSTEM BASED ON A SECURED MODELING EXCHANGE,” which is incorporated by reference in its entirety.

### FIELD OF THE DISCLOSURE

Embodiments of the present disclosure are related to machine learning (ML); more particularly, embodiments disclosed herein related to training and exchanging of ML models.

### BACKGROUND

Machine learning (ML) models have become more prevalent today. They are useful in making predictions and automating tasks. These ML models are created by taking a known set of input data and responses to that data and training each ML model to generate predictions for the response to new data. In other words, an ML model undergoes a process by which the model is trained to make predictions or decisions based on data.

As training of an ML relies on the input data, the more data that is available to train the ML model, the more likely the ML model will be able to make predictions more accurately. However, often there is difficulty in obtaining all the input data that would be useful in training an ML model. The difficulty may be due an unwillingness to share certain data with others as certain sets of data have value to those that have it or the sharing of such data may be restricted due to its content. For example, some entities may be unable legally to share certain data due to data privacy restrictions. Thus, the current training of ML models can be constrained by the availability of training data.

### SUMMARY

Architectures, apparatuses and methods for building data learning systems (e.g., machine learning (ML) systems, etc.). In some embodiments, an architecture to build a global machine learning (ML) model includes a platform to identify a group of clients to build a global model by federated learning. In some embodiments, the platform includes a group manager to build the global model by supplying a model definition for the global model to the group and aggregating model parameters received from the group to build the global model, the model parameters being generated by the clients training a local ML model at their respective client sites using local data at their respective client sites; and an incentive calculator communicably coupled to the group manager to calculate an incentive to each client communicably coupled to the platform based on said each client's contribution to train the global model, each client's contribution including one or more model parameters generated as a result of training their local ML model with local data.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates some embodiments of a horizontal federated learning (HFL) framework.

FIG. 2 illustrates some embodiments of an architecture of the data learning system.

FIG. 3 illustrates some embodiments of an FL hub.

FIGS. 4A-4E are data flow diagrams of some embodiments of processes performed by a data learning architecture.

FIG. 5A-5E illustrate some embodiments of processes for generating incentives between the group and FL clients performing the training of local models.

FIG. 6 illustrates an arrangement between FL hubs and one or more FL model users and FL model clients.

FIG. 7 illustrates some embodiments of a hierarchical relationship between FL clients performing the local model training and FL hubs that are creating and updating a global model.

FIG. 8 represents an example machine-learning architecture used to train a machine-learned model.

FIG. 9 represents some embodiments of an example model using a convolutional neural networks (CNN) to process an input image.

FIG. 10 illustrates a block diagram of some embodiments of a computing device.

### DETAILED DESCRIPTION

In the following description, numerous details are set forth to provide a more thorough explanation of the present disclosure. It will be apparent, however, to one skilled in the art, that the present disclosure may be practiced without these specific details. In other instances, well-known structures and devices are shown in block diagram form, rather than in detail, to avoid obscuring the present disclosure.

Embodiments disclosed herein include a platform for creating machine learning (ML) models and methods for using the same. In some embodiments, the platform allows users to join and build ML models together using a federated learning technique. That is, in some embodiments, the platform leverages federated learning to build ML models. In some embodiments, the users of the platform include developers and/or data scientists.

In some embodiments, the platform enables users to create groups in which any group member can contribute to the building of a global ML model. These contributions to building a global model are created by clients training a local ML model under a local site using local raw data. In some embodiments, the local data does not have to be shared with the platform. In other words, contributors can contribute to building the global model by performing training of their own version of the ML model and then sharing the results of the training with the platform. In some embodiments, the platform generates incentives based on the amount of contribution made by the users toward building the global ML model. These incentives motivate contributions to the model building process.

Although the performance of the ML model built by federated learning becomes better as the number of clients increases, collecting enough clients that have data for training is often challenging. Embodiments of the invention solve this problem by providing the platform referred to as the federated learning (FL) hub to enable the ML model to be built for use by a community of model users. In some embodiments, the FL hub allows users to make open requests to build ML models through federated learning and then get access to the models that are built.

The FL hub encourages clients to join the federated learning and make a contribution to the building of the model. This is in contrast to the past where data scientist or developers needed to find clients and asked them to join federated learning. In some embodiments, the contributions include the results of clients, referred to herein as FL clients, training a local model with local data and then providing those results to the FL hub to enable a global model to be built and/or improved to achieve better performance. In some embodiments, the FL client joins the group to contribute to building the global FL model by providing parameters of their local FL model built by the client data and earns an incentive based on the amount of the contribution to the building of the global model. In some embodiments, the FL client is reputed by the amount of contribution and their model's accuracy.

In some embodiments, the platform includes a group manager and an incentive calculator. The group manager manages a group of clients, referred to herein as FL clients, that join and build the global model. The group manager includes registries for storing the model definition. In some embodiments, the model definition includes model format and feature format of the model. In some embodiments, the incentive calculator calculates an incentive for the FL clients based on their contribution to the building of the global model. In some embodiments, the incentive calculator has databases and/or other registries for storing training/trading histories.

In some embodiments, model users can use the global model that is generated. These model users can be the users that requested the global model be built. In some embodiments, model users gain access to the global model through an inference API or can download the global model from the FL hub.

Thus, some embodiments of the platform described herein enable the distributed machine learning technique and a way to train an ML model while preserving private data stored on each client for the (e.g., without sharing data with each other). This overcomes two major challenges in developing ML today. First, using the platform described herein allows the users to create a model while maintaining compliance with privacy policies such as, for example GDPR, CCPA, etc. and while avoiding having to transfer large amounts of raw data for machine learning.

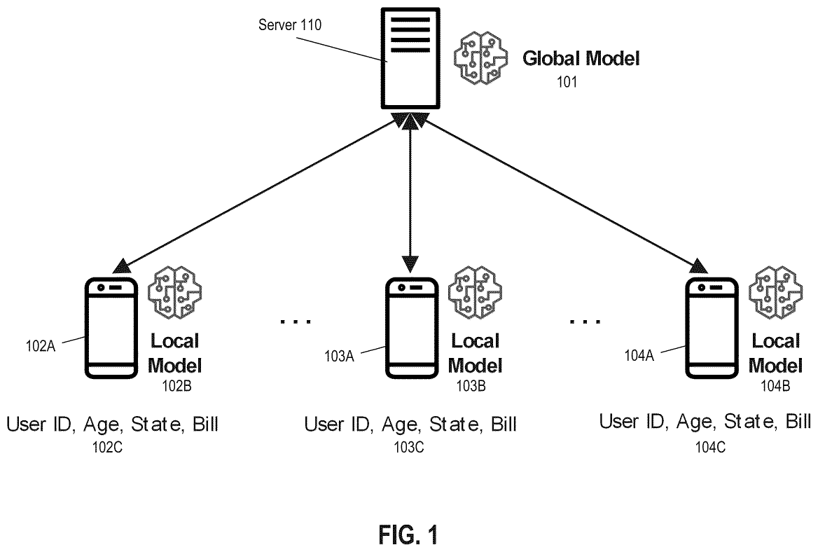

FIG. 1 illustrates some embodiments of a horizontal federated learning (HFL) framework. In HFL, each client has the same feature set and many of the clients have small data sets by which to train a model. In some embodiments, the clients comprised mobile devices (e.g., mobile phones, portable computers, etc.). Referring to FIG. 1, mobile devices 102A-104A include local ML models 102B-104B, respectively, and train their associated local ML models using data 102C-104C. After training the local model, the results of the training are sent to server device 110 for creating and/or improving global model 101. In such a case, server device 110 operates as a federated learning hub.

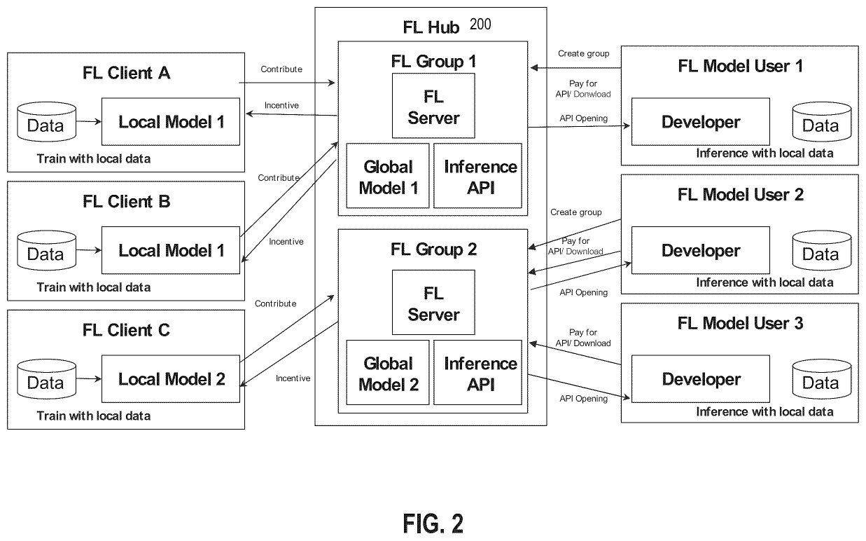

FIG. 2 illustrates some embodiments of an architecture of the data learning system. Referring to FIG. 2, the architecture includes FL hub 200 along with FL model users and FL clients. As shown, the architecture includes FL model users 1-3 and FL clients A-C. However, the architecture is not limited to three FL model users and three FL clients. In some other embodiments, the architecture may include any number of model users and any number of FL clients.

In some embodiments, the FL model users send requests to have groups created by FL hub 200 to create one or more global models. In some embodiments, the FL hub 200 receives a create group request from one or more FL model users, such as FL model users 1-2. In response to each of the create group request, FL hub 200 creates a group such as FL group 1 in response to a create group request from FL model user 1 and FL group 2 in response to a create group request from FL model user 2 such as is shown in FIG. 2.

Each of FL groups 1 and 2 is for creating a global model that is to be trained by one or more of FL clients A-C. For example, FL group 1 is created to build global model 1, while FL group 2 is created to build global model 2. In some embodiments, each of the FL groups, such as FL group 1 and 2, includes an FL server to facilitate building the group's model as well as inference API that allows FL model users to gain access to and utilize the global model that is created for the group. For example, FL group 1 includes an FL server, global model 1 and an inference API, and FL group 2 includes an FL server, global model 2, and an inference API.

When a group has been set up, FL hub 200 enables access by FL clients A-C to contribute to creation and training of one or more of the global models, such as global model 1 of FL group 1 and global model 2 of FL group 2. For example, FL clients A and B contribute to the building of global model 1 of FL group 1, while FL client C contributes to the building of global model 2 of FL group 2. In some embodiments, the contributions from FL clients A-C are in the form of parameters for their associated global model. These parameters are generated by the FL clients as a result of training a local model with their local (raw) data. For example, FL client A trains local model 1 (a local version of global model 1) with local data to generate parameters that are contributed to the building of global model 1, FL client B trains local model 1 (a local version of global model 1) with local data to generate parameters that are contributed to FL group 1 to build global model 1, and FL client C trains local model 2 (a local version of global model 2) with local data to generate parameters that are contributed to create global model 2 of FL group 2.

In response to contributions, the FL hub aggregates the contributions to create global models. For example, the FL server of FL group 1 receives the contributions for FL client A and FL client B and uses these contributions to create global model 1. Similarly, FL server of FL group 2 receives the contributions from FL client C to create global model 2. In response to receiving the contributions, FL hub 200 provides incentives to FL clients A-C. For example, the FL server of FL group 1 provides incentives to both FL clients A and B for their contributions to the creation of global model 1, while the FL server of FL group 2 provides incentives to FL client C for its contributions in creating global model 2.

After the global models are created by FL hub 200, they are made accessible to the FL model users, such as, for example, FL model users 1-3. For example, FL model user 1 can access global model 1 after its built and use global model 1. Similarly, FL model users 2 and 2 may access global model 2 of FL group 2 after it's been built.

In some embodiments, the access to the global models by the FL model users is by downloading the global model for use. In some other embodiments, the FL model users use gain access by submitting local data to the FL hub 200 for using the model to the API and updating their inferences in response to the local data. More specifically, in some embodiments, the access by FL model users, such as FL model users 1-3 is thorough the inference API of the group. For example, FL model user 1 accesses global model 1 using an API opening of the inference API of FL group 1 and uses local data to generate an inference using global model 1. Similarly, FL models users 2 and 3 utilize that an inference API of FL group 2 which provides an API opening to model users 2 and 3, to gain access to global model 2 and be able to generate an inference with local data using the global model 2.

In some embodiments, the FL model users pay for access to the global model. The payment can be for use of the API and/or for downloading the global model itself.

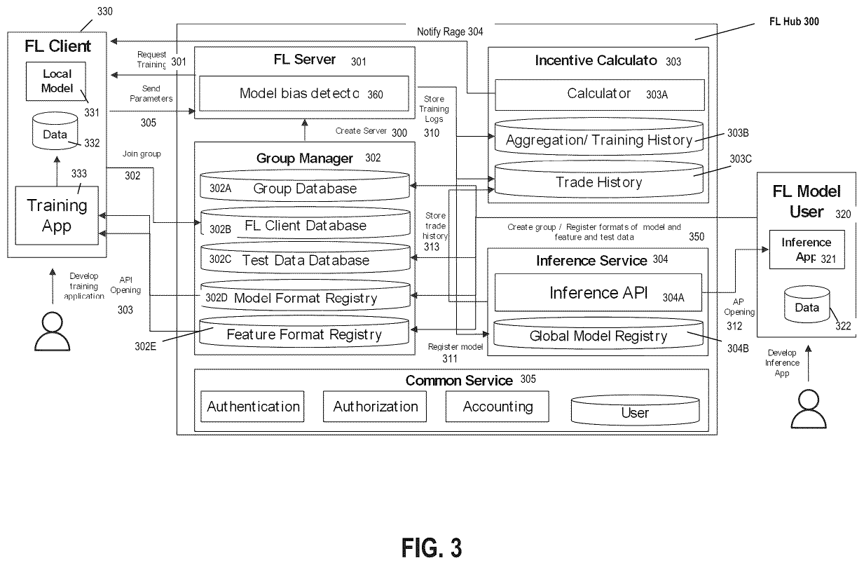

FIG. 3 illustrates some embodiments of an FL hub. Referring to FIG. 3, FL hub 200 includes FL server 301, group manager 302, incentive calculator 303, inference service 304, and common service module 305. These components comprise one or more processers to perform operations with respect to interacting with FL clients and FL model users to create global models via local training done by FL clients on local models with local data and with respect to enabling access by FL model users to the global models after they have been built by FL hub 200.

Group manager 302 is responsible for creating and managing the groups that are set up and requested to create global models for use by FL model users after training of the global models using contributions from FL clients. Incentive calculator 303 is responsible for managing incentives that are provided to FL clients as compensation for the results of their training of local versions of the model that are used to create global models. Inference service 304 is responsible for enabling access to global models created by FL hub 300 by FL model users. Common service module 305 includes a number of services, such as authentication services to authenticate model users and FL clients, authorization services to authorize one or more actions and the access by FL clients and FL model users, an accounting module for handling accounting functions, and a user database for storing user information.

In operation, FL hub 300 creates a group to generate a global model in response to a create group request 350 from an FL model user, such as FL model user 320. In some embodiments, create group request 350 includes a request to create the group and includes information to register the formats of the model and the feature set along with test data that may be used by FL hub 300 as part of creating and testing the global model. In some embodiments, create group requests 350 is sent to and received by group manager 302. Group manager 302 creates a group and stores the group in a group database 302A, stores the test data in test database 302C, stores the model format in model format registry 302D, and stores the feature set format in registry 302E.

Once the group is created by group manager 302, group manager 302 creates FL server 301 (server resources) in response to sending FL server 301 a create server request 300. After FL server 301 is created, FL server 301 requests FL clients, such as FL client 300, to perform local model training using local data to create parameters to be used to build a global model. In some embodiments, FL server 301 requests training of a local model by FL clients by sending a request training request, such as request training request 301, to FL client 330. Note that request training request 301 may be sent before FL client 330 joins a group for training the global model of the group. In some embodiments, after a group is created, group manager 302 provides an indication that there is a global model that needs to be built and FL clients desiring to help build that global model may join the group. This indication can be an indication provided via the web (e.g., a web-based indication) or a direct solicitation from group manager 302. In some embodiments, group manager 302 and an FL client 330 can exchange messages prior to joining the group to enable the FL client 330 to inform group manager 302 as to what data is has or has access to in order to allow group manager 302 to make an informed decision as to which global models that FL client 330 would be useful in training and thereafter notify when a group is being set up to train a particular model.

In some embodiments, FL client 330 sends a join group request 302 to group manager 302 to join the group to enable the FL client 330 to train a local version of the global model to help build the global model. In response to joining the group, training application 333 of FL client 330 obtains the model format from model from registry 302D and feature format for feature format registry 302E using an API opening communication 303. The model format and feature format are used by training application 333 along with local data 332 to train local model 331, which is a local version of the global model. In some embodiments, after training local model 331, FL client 330 sends one or more parameters generated as a result of the training their local model, via parameters communication 305, to the FL server 301 which uses the received parameters to create and/or improve the global model associated with the group. In some embodiments, the parameters include local model weights and biases, which are sent to FL service 301, which aggregates the parameters from the clients.

As part of the process, incentive calculator 303 calculates an incentive with calculator 303A. The incentive is provided by FL hub 300 to an FL client that trained a local model to help build the global model. Incentive calculator 303 notifies the FL clients of their incentive (e.g., rate) using notify rate communication 304.

After receiving the parameter(s) sent by the FL clients developed by training their local models, FL server 301 stores the training logs (310) in the aggregation/training history database 303B as well as trade history 303C of incentive calculator 303. The FL server 301 also sends the generated global model to global model registry 304B of inference service 304 to enable access to global model. Subsequently, an FL model user, such as FL model user 302, uses an inference application 321 along with its local data to use the global model by communicating with inference API 304A.

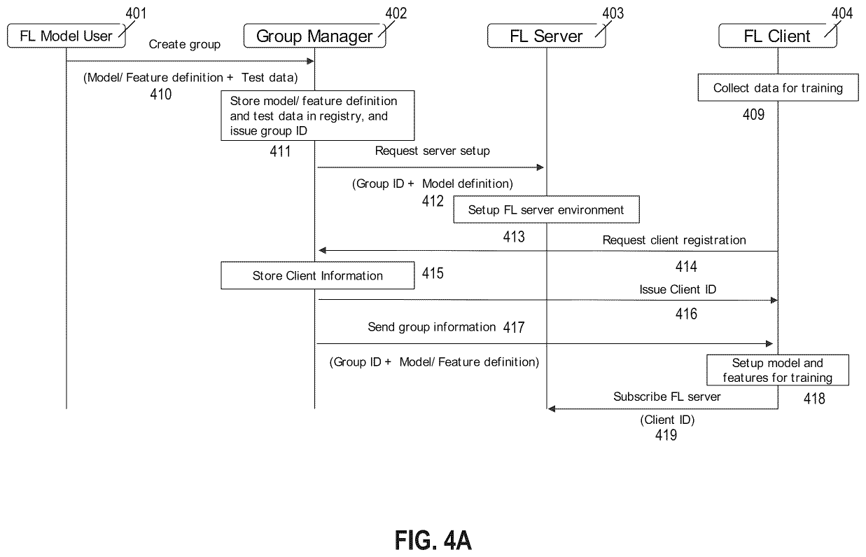

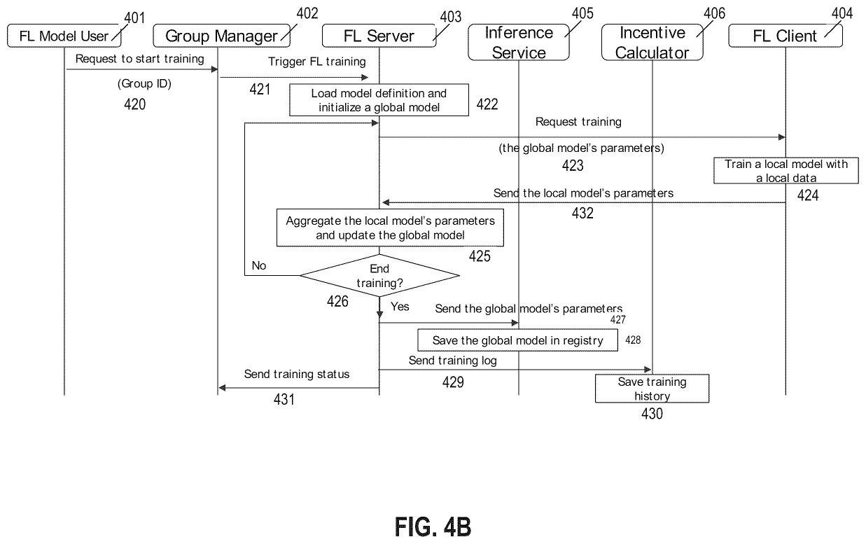

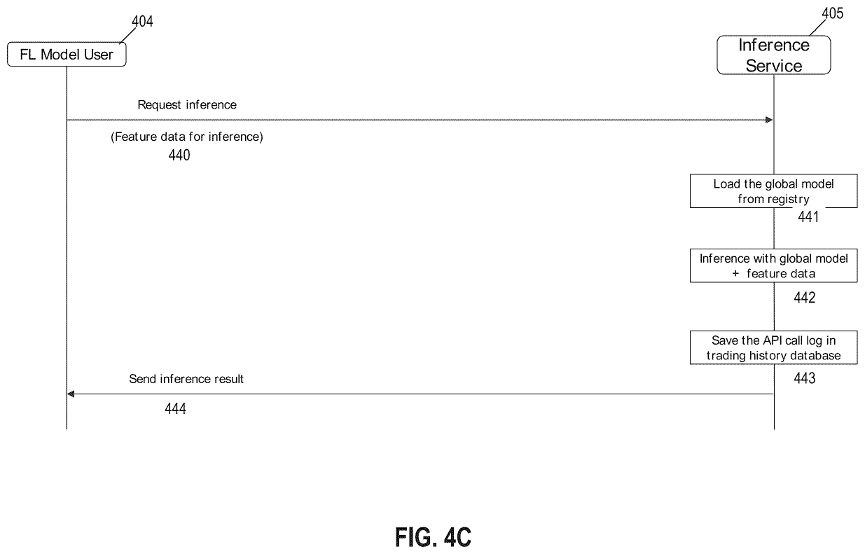

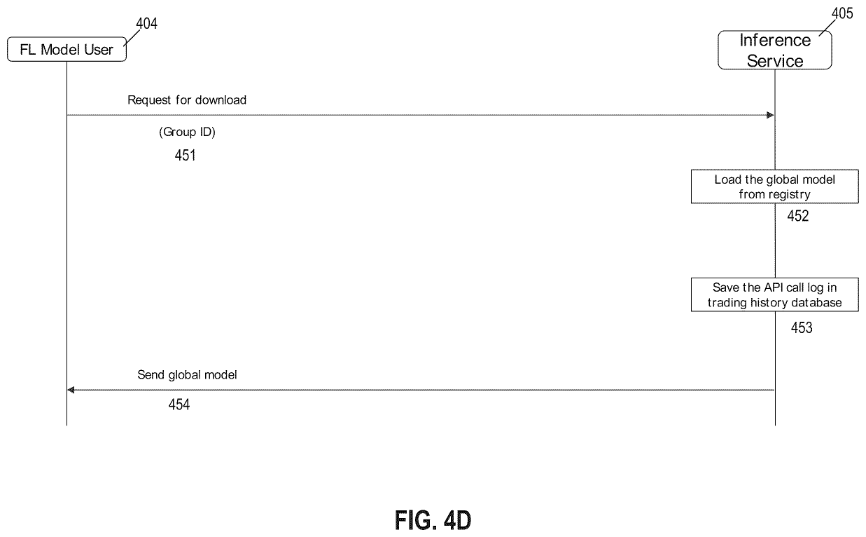

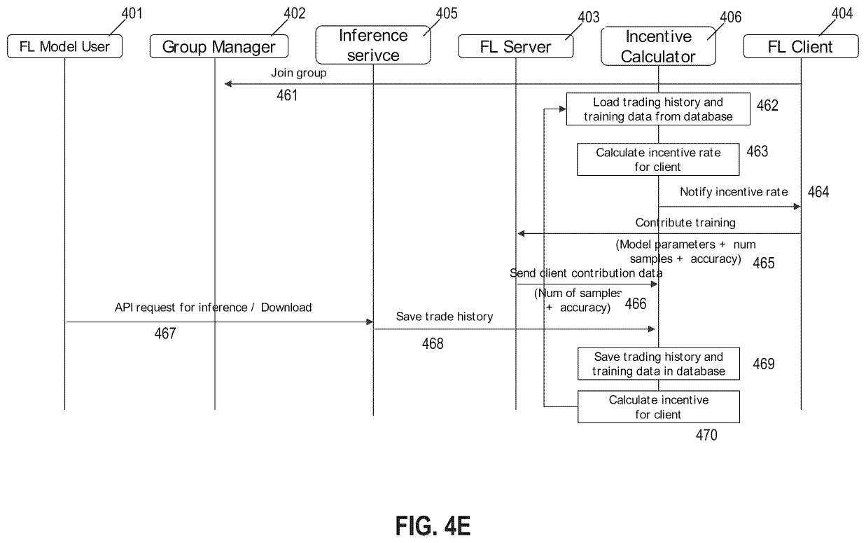

FIGS. 4A-4E are flow diagrams of some embodiments of processes performed by a data learning architecture. More specifically, FIG. 4A illustrates a data flow diagram of a process for initializing a federated learning (FL) environment. Referring to FIG. 4A, the process begins by FL model user 401 sending a request to group manager 402 to create a group to create a global model (processing block 410). In some embodiments, the request includes a definition of the model that is to be created, a feature set associated with the model, and test data that can be used to verify the accuracy of the model after creation.

In response to receiving this request, group manager 402 stores the definition of the new model to be generated, the feature set definition, and the test data in respective registries and issues a group identifier (ID) that identifies the group that group manager 402 has set up to create the new model (processing block 411). Thereafter, group manager 402 sends a request to set up a server to FL server 403 (processing block 412). In some embodiments, the request to set up the server includes a group ID and the model definition. In response to the request, FL server 403 sets up an FL server environment to support the group associated with the group ID (processing block 413).

Before or during the time of setting up the group, FL client 404 collects data for training a local model (processing block 409). After the group has been set up, the FL client 404 sends a request to register as a client to the group manager 402 (processing block 414). In response to the request, group manager 402 stores client information about FL client 404 (processing block 415) and sends a client ID to FL client 404 (processing block 416), as well as the group information regarding the group to FL client 404 (processing block 417). In some embodiments, the client information that is stored includes a client ID, client device information (e.g., device type, central processing unit (CPU) architecture, operating system (OS)) and status (e.g., connected, disconnected) and registered in the group manager. In some embodiments, the group information that is sent includes the group ID as well as the model and feature definition. In response to the group information, FL client 404 sets up the model and features for training a local model (processing block 418). Thereafter, FL client 404 subscribes to the FL server 403 to indicate that the initialization of the environment for creating the global model has been completed (processing block 419). In some embodiments, the subscription request includes a client ID of the FL client 404.

FIG. 4B illustrates a data flow diagram of some embodiments of an FL training process. Referring to FIG. 4B, the process begins by FL model user 401 sending a request to start training to group manager 402 (processing block 420). In some embodiments, the request to start training includes a group ID that identifies to the group manager 402 the group for which FL model user 401 desires to contribute to the training of the global model. In response to receiving the request to start training, group manager 402 triggers the FL training by sending a request to FL server 403 (processing block 421). In response to receiving the request, FL server 403 loads the model definition and initializes a global model (processing block 422). In some embodiments, as part of initializing the global model, the server creates an initial global model based on the model definition. The model can be initialized with either random parameters (e.g., weights and biases) or the parameters that are pre-trained or pre-defined before the training.

After loading the model definition and initializing a global model, FL server 403 sends a request for training to FL client 404 as well as any other clients that are going to train their local models with local data to contribute to creation of the global model of the group (processing block 423). In some embodiments, the request to perform the training includes the global model's parameters, and the contribution by FL client 404 is parameters for the global model that are generated by FL client 404 training the local model with the local data.

In response to the request for training received from FL server 403, FL client 404 (and the other FL clients generating parameters for the global model) train their local model with their local data (processing block 424) and send the local model's parameters generated as a result of training a model to the FL server 403 (processing block 432). After receiving the parameters for the local models from FL client 404 and any other client performing local training of their local model for the group, FL server 403 aggregates the local model's parameters and updates the global model (processing block 425). In some embodiments, the global model consists of parameters (e.g., weights and biases), and to update the model, the server aggregates local model parameters that are sent from the clients and the aggregation result is the new global model parameters. There are a number of aggregation techniques that the server can use to aggregate local model parameters that are sent from the clients. For example, in some embodiments, the server aggregates the local model parameters by using a weighted average where the weighting is based on the amount of data each client has to training the model and/or the data's accuracy. Once the server gets the new parameters, it replaces the existing global model parameters with the new parameters.

Then the FL server 403 determines whether training has ended (processing block 426). In some embodiments, the end of training is based on an expiration of a training time period covering the time by which the training was to be completed. In some other embodiments, the end of training is signaled or provided by one or more FL model users, such as FL model user 401. In yet some other embodiments, the end of training is based on the number of iterations, which are defined as epochs. In some embodiments, model users can also set epochs so that the training can be completed if the number of the iterations is reached. In some embodiments, after each iteration, the FL clients send updated local model parameters which the FL server 403 aggregates for updating global model.

If training has not ended, the process returns to processing block 423 where the FL server 403 can request additional training to be performed by the FL clients registered for the group. If training has ended, processing logic of the FL server 403 sends the global model's parameters to an inference service 405 (processing block 427), which saves the global model in the registry (processing block 428). FL server 403 also sends a training log to the incentive calculator 406 (processing block 429), which saves the training log in a training history (processing block 430).

Subsequently, the FL server 403 also sends a training status to the group manager to indicate the state of training that the global model is currently in (processing block 431). Such a status can indicate that the training has ended and that the global model is ready for use. In some embodiments, the training status may indicate that training is underway and/or that training has not yet started.

FIG. 4C is a data flow diagram of some embodiments of a process for using the inference application programming interface (API). This process is used when the global model is available for use by an FL model user, such as FL model user 404. Referring to FIG. 4C, the process begins by FL model user 404 requesting an inference, from inference service 405, to be generated as a result of using a global model (processing block 440). In some embodiments, the request for an inference includes feature data to be used by the global model when generating or otherwise obtaining the inference. The request can include a pointer or a resource locator (e.g., URL, etc.) indicating a location (e.g., database, etc.) at which the FL server can gain access to the feature data to be used by the global model. In response to the request for the inference, the inference service 405 loads the global model from the registry (processing block 441), generates the inference with the global model using the feature data (processing block 442), and saves the API call log in a trading history database to record that FL model user 404 had used the global model (processing block 443). Thereafter, inference service 405 sends the inference results back to FL model user 404 (processing block 444).

FIG. 4D is a flow diagram of some embodiments of a process of downloading a global model by an FL model user. Referring to FIG. 4D, the process begins by FL model user 404 sending a request to download the global model from the inference service 405 (processing block 451). In some embodiments, the request for download includes a group ID to identify the group associated with the global model so that the inference service 405 knows which global model to provide to FL model user 404. In response to receiving the request for the download, inference service 405 loads the global model from a registry (processing block 452), saves the API call log in the training history database to indicate that FL model user 404 has requested and been sent a download of the global model (processing block 453), and sends the global model to FL model user 404 (processing block 454). In some other embodiments, instead of sending the global model to FL model user 404, the inference service 405 provides FL model user 404 access to the global model to enable FL model user 404 to download the model.

FIG. 4E illustrates the data flow diagram of some embodiments of a process for calculating an incentive (rate) that is provided to the FL clients doing the model training. Referring to FIG. 4E, the process begins by FL client 404 sending a request to join a group to group manager 402 (processing block 461). While group manager 402 is receiving the request to join a group, incentive calculator 406 loads a training history and training data from the database (processing block 462) and calculates an incentive rate for the FL client (processing block 463). In some embodiments, the incentive rate is amount of money or other renumeration that compensates FL client for performing its local training and contributing to the creation and/or update of the global model. Incentive calculator 406 notifies FL client 404 of the incentive rate (processing block 464).

Subsequently, FL client 404 trains a local model with local data and contributes the results of the training (e.g., one or more parameters) to FL server 423 (processing block 465). In some embodiments, the contribution includes model parameters, a number of samples and an indication of accuracy. In some embodiments, the indication of accuracy is an indication of how well the local model produced results that matches the test data that was provided by group manager 402 as part of the model/feature definition that was provided prior to training.

In response receiving the contribution that resulted from the training performed by FL client 404, FL server 403 sends the client contribution data to incentive calculator 406 (processing block 466). In some embodiments, the client contribution data indicates the number of samples of data provided by the FL client 404 as well as its accuracy indication.

Thereafter, FL model user 401 requests to use of a global model to produce an inference or to download the global model (processing block 467). In some embodiments, a request is sent to inference service 405 which saves the training history in response to that request (processing block 468) by sending the training history to incentive calculator 406. In response to receiving the trade history, incentive calculator 406 saves the trading history and training data in a database (processing block 469) and calculates an incentive for the FL client as compensation for their contribution (processing block 470). The calculated incentive can be used for future FL clients that will be training the same model and/or different models being developed by group manager 402.

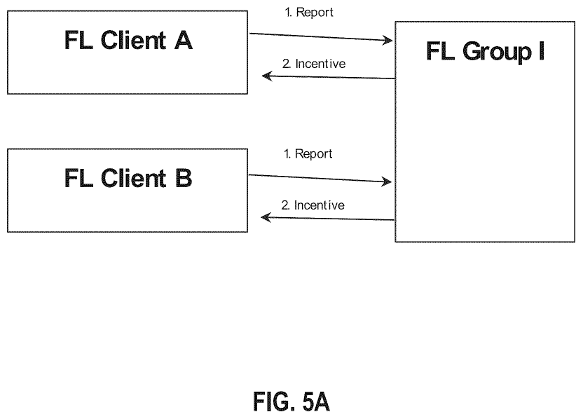

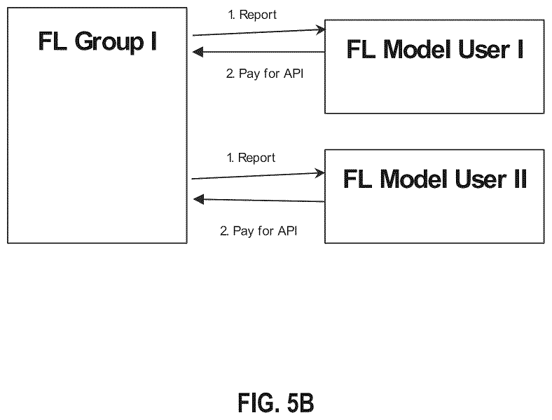

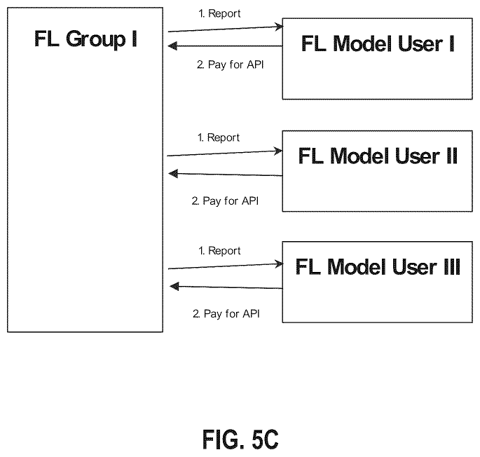

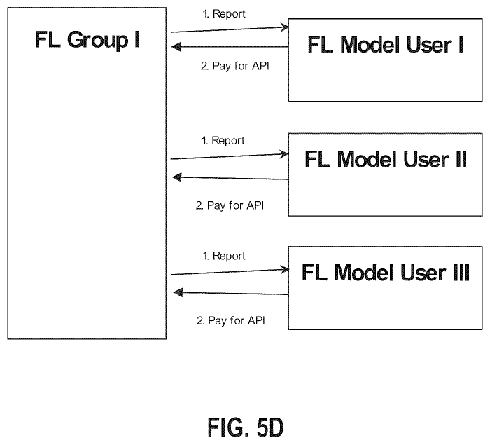

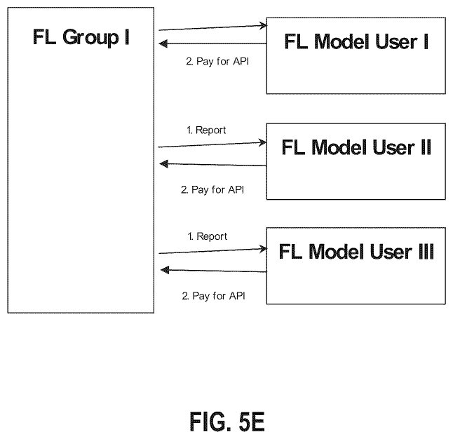

FIGS. 5A-5E illustrate processes for generating incentives between the group and FL clients performing the training of local models using local data and FL model users that request use of the global models after their creation and training has been completed. More, specifically, FIG. 5A illustrates that an overall framework of the interaction between FL clients performing local training to create the global model and the group manager. Referring to FIG. 5A, FL clients A and B that perform local model training using local data send a report to the FL group 1 of the of the group manager of the FL hub. In some embodiments, these reports may indicate the number of the samples of a client's data set as well as evaluation results based on the client's test data. The evaluation results may include an indication of the accuracy of the local model being trained by each of the FL clients, such as FL client A and B.

After reporting the information, FL group 1 provides an incentive to each of FL clients A and B. In some embodiments, the incentives are based on the number of samples and the accuracy. An example of an incentive calculation calculated by incentive calculator is given below.

In the samples and accuracy from FL clients A and B are as follows:

#Samples=10K, Accuracy=90% Client A:

#Samples=20K, Accuracy=80% Client B:

then, the incentive rate is calculated by the incentive calculator as

$$Client A : ( 10 K * 90 \% ) / ( 10 K * 90 \% + 20 K * 80 \% ) = 36 \% \\ Client B : ( 20 K * 80 \% ) / ( 10 K * 90 \% + 20 K * 80 \% ) = 64 \%$$

In some embodiments, in cases where FL clients may start or are expected to start the training process at different times, the FL server can wait until an initial group of a certain number or clients or threshold of clients (e.g., 50%, 80%, 90%, etc.) are available and/or ready to start the training process before determining the incentive rate and those would share in the threshold amount of the incentive rate (e.g., 50%, 80%, 90%, etc.). Thereafter, the other FL clients that start the training process after the initial group can have an equal share the remaining incentive rate or have a share it based on their number of samples and accuracy as described above.

In order to prevent FL clients from reporting inaccurate or malicious information regarding the model, in some embodiments, the group manager sends the ML software to the client. More specifically, when this occurs, the ML software sent from the group automatically executes an ML training process in the client and then automatically calculates the information (the number of samples and accuracy) based on the training process, which the software automatically sends to the group. In this workflow, the client cannot intervene and cannot change the information. Note that in some embodiments, the accuracy is determined using validation data or through the use of test data and its comparison to the model data.

FIG. 5B illustrates the process for generating an incentive for the situation where the global model cannot be downloaded by the FL model user, and the FL model user can send the user's test data with a label for determining the accuracy (though the Group can calculate accuracy). Referring to FIG. 5B, FL model users, such as FL model users 1 and 2, send their test data with a label to an FL group, such as FL group 1. FL group 1 is associated with a global model and reports an inference from using data from the FL model user with the global model. FL model users 1 and 2 can determine the accuracy of the use of the model. More specifically, the manager for the group knows the number of samples they used in a data set and the evaluation results based on the usage test data set and provides these to the FL model users 1 and 2. Thereafter, in response to receiving the reports, the FL model users pay for use of the API.

An example of an incentive calculation associated with the use of the model is calculated by incentive calculator as given below.

In the case of

#Samples=5K, Accuracy=70% Model User 1:

#Samples=1K, Accuracy=80% Model User 2:

then the incentive rate is calculated by the incentive calculator as

$$Model User 1 : ( 5 K * 70 \% ) / ( 5 K * 70 \% + 1 K * 80 \% ) = 81 \% \\ Model User 2 : ( 1 K * 80 \% ) / ( 5 K * 70 \% + 1 K * 80 \% ) = 19 \%$$

FIG. 5C illustrates some embodiments of a process for providing an incentive to FL model user from the group in a case where the global model is not downloadable and the results of an inference are provided. In this case, the FL model users cannot determine the accuracy of the results, and the FL group 1 knows the number of samples from the users' test data (and knows that the FL model user cannot determine accuracy). The FL group 1 provides a report to each of the FL model users I-III and the FL model users pay an incentive for the use of the global model. In some embodiments, the incentive is determined according to the example given below. If the number of samples in the FL model users test data is

#Samples=5K Model User 1:

#Samples=3K Model User 2:

#Samples=8K Model User 3:

then the incentive rate is calculated by the incentive calculator as

$$Model User 1 : 5 K / ( 5 K + 3 K + 8 K ) = 31 \% \\ Model User 2 : 3 K / ( 5 K + 3 K + 8 K ) = 19 \% \\ Model User 3 : 8 K / ( 5 K + 3 K + 8 K ) = 50 \%$$

Note that this situation the FL Group I does not care about the accuracy of the model user.

FIG. 5D illustrates some embodiments for a process are generating an incentive between a group manager and a FL model user. In this situation, the model is downloadable and the user owns their data set with a label so the FL model user know its accuracy, and the FL model users report to the group the number of samples of the users' test data and the evaluation results based on the user's test data set.

The FL Group I manager sends a report with the incentive to each of the FL model users.

In some embodiments after receiving the report from the FL Group I, FL model users I-III pay for the use of the API to download the model. In some embodiments, the incentive for each of the model users pay is calculated according to the following example. In the case of

#Samples=5K, Accuracy=70% Model User 1:

#Samples=3K, Accuracy=80% Model User 2:

#Samples=8K, Accuracy=90% Model User 3:

then the incentive rate is calculated as

$$Model User 1 : ( 5 K * 70 \% ) / ( 5 K * 70 \% + 3 K * 80 \% + 8 K * 90 \% ) = 27 \% \\ Model User 2 : ( 3 K * 80 \% ) / ( 5 K * 70 \% + 3 K * 80 \% + 8 K * 90 \% ) = 18 \% \\ Model User 3 : ( 8 K * 90 \% ) / ( 5 K * 70 \% + 3 K * 80 \% + 8 K * 90 \% ) = 55 \%$$

To prevent users from reporting inaccurate information (e.g., the global model is faulty), the FL Group I manager can ask the model users to provide the data set to the hub so that it can make its own determination of how accurate the model is.

FIG. 5E illustrates some embodiments of a process for generating an incentive between group and a model user in the case where the global model is downloadable and the FL model user cannot determine the accuracy of the model. Referring to FIG. 5E, the FL Group I manager reports to each of the FL model users 1-3. In some embodiments, the report includes the incentive. The FL model users I-III report to FL group 1 the number of samples of the user's data set and the rating. In some embodiments, the rating is determined according to the following example. If the ratings include: (1) very bad, (2) bad, (3) average, (4) good, (5) very good, in the case of

#Samples=5K, Rating=4/5 Model User 1:

#Samples=3K, Rating=3/5 Model User 2:

#Samples=8K, Rating=1/5 Model User 3:

then the incentive rate is calculated by the incentive calculator as

$$Model User 1 : 5 K * 4 / ( 5 K * 4 + 3 K * 3 + 8 K * 1 ) = 54 \% \\ Model User 2 : 3 K * 3 / ( 5 K * 4 + 3 K * 3 + 8 K * 1 ) = 24 \% \\ Model User 3 : 8 K * 1 / ( 5 K * 4 + 3 K * 3 + 8 K * 1 ) = 22 \%$$

To prevent users from reporting inaccurate information regarding the use of the global model, the FL Group I manager compares the ratings among the model users, and if a model user gives excessively low ratings, then the mean rating can be blacklisted. In some embodiments, the FL Group I manager can ask if a model user can provide the data set to the hub so it can perform its own determination of how good the model is.

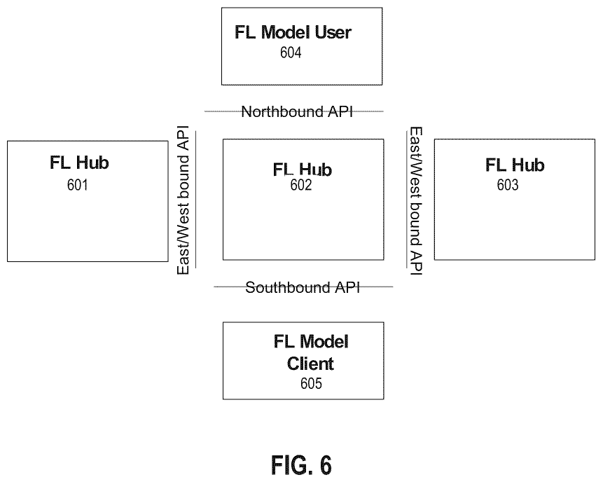

FIG. 6 illustrates an arrangement between FL hubs and one or more FL model users and FL model clients. Referring to FIG. 6, there are three FL hubs 601-603 that are able to operate with each other via APIs. In this way, they can support the generation of a single global model or multiple global models individually. Note that the number of FL hubs that can work together can be less than or greater than three. In some embodiments, an FL model user such as FL model user 604 and FL model client model, such as FL client 605, are able to interact via APIs with one or more of FL hubs 603. For example, in some embodiments, a FL model user such as FL model user 604 and an FL client, such as FL model client 605, can interact only with FL hub 602 via APIs, yet get the benefit of the operations of FL hubs 601 and 603 which interact directly with FL hub 602 via APIs.

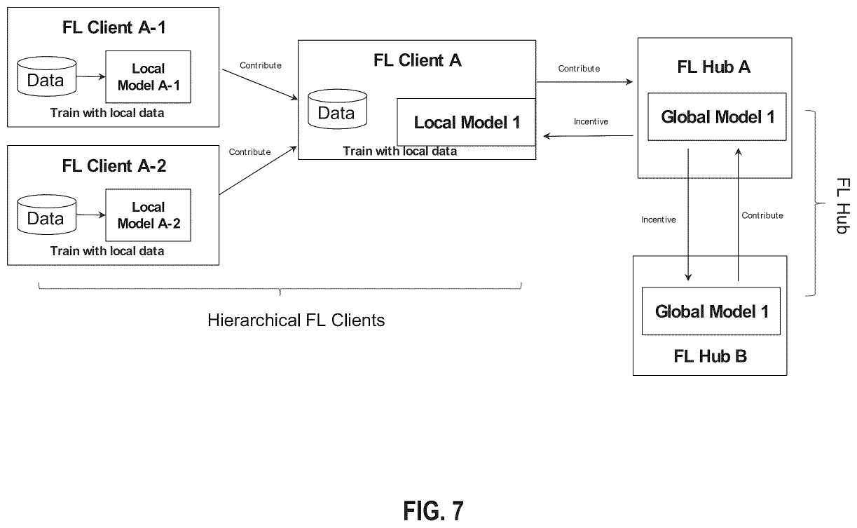

FIG. 7 illustrates some embodiments of a hierarchical relationship between FL clients performing the local model training and FL hubs that are creating and updating a global model. Referring to FIG. 7, FL client A-1 and FL client A-2 each include local models A-1 and A-2, respectively, and train those local models with local data. The results of the local model training performed by FL client A-1 and FL client A-2 is provided as contributions (e.g., parameters) to FL client A, which also trains local model 1 using the local data and the contributions from FL clients A-1 and A-2. Thus, FL client A aggregates the results provided by FL client A-1 and A-2 to help train local model 1 because FL client A-1 and FL client A-2 are in a hierarchical relationship with FL client A. In some embodiment, FL client A performs aggregation in the same manner as aggregation is performed for the global model.

Subsequently, after FL client A trains local model 1, FL client A provides a contribution to FL Hub A to update and/or create global model 1. In response to that contribution, FL hub A provides incentive to FL client A. Note that in some embodiments, FL Hub A is in a relationship with another hub such as, for example, FL Hub B, which is also updating its version of global model 1. FL Hub B can provide a contribution to FL Hub A to be used to update global model 1. In response to the contribution, FL Hub A may provide incentive to FL Hub B.

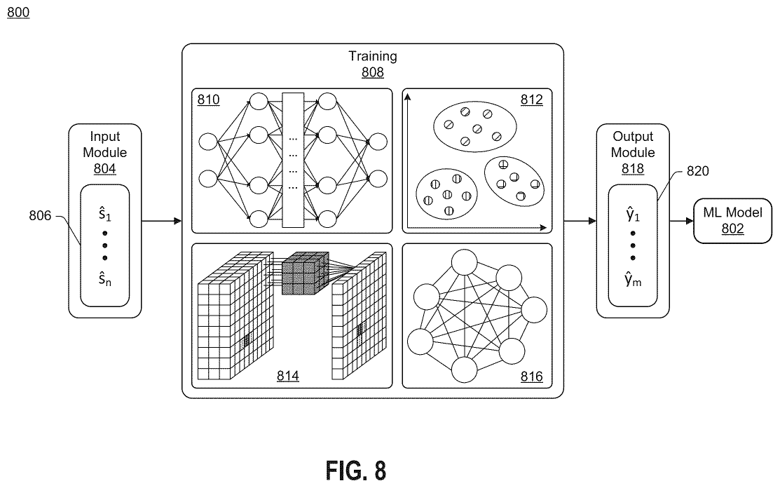

FIG. 8 represents an example machine-learning architecture 800 used to train a machine-learned model 802. An input module 804 accepts an input ŝ 806, which can be an array with members ŝ1 through ŝn. The input ŝ 806 is fed into a training module 808, which processes the input ŝ 806 based on the machine-learning architecture 800. For example, if the machine-learning architecture 800 uses a multilayer perceptron (MLP) model 810, the training module 808 applies weights and biases to the input ŝ 806 through one or more layers of perceptrons, each perceptron performing a fit using its own weights and biases according to its given functional form. MLP weights and biases can be adjusted so that they are optimized against a least mean square, log cosh, or other optimization function (e.g., loss function) known in the art. Although an MLP model 810 is described here as an example, any suitable machine-learning technique can be employed, some examples of which include but are not limited to k-means clustering 812, convolutional neural networks (CNN) 814, a Boltzmann machine 816, Gaussian mixture models (GMM), and long short-term memory (LSTM). The training module 808 provides an input to an output module 818. The output module 818 analyzes the input from the training module 808 and provides an output in the form of ŷ 820, which can be an array with members ŷ1 through ŷm. The output 820 can represent a known correlation with the input ŝ 806, such as, for example, object identification, segmentation, and/or classification.

In some embodiments, the input ŝ 806 can be a training input labeled with known output correlation values, and these known values can be used to optimize the output ŷ 820 in training against the optimization/loss function. In other embodiments, the machine-learning architecture 800 can categorize the output ŷ 820 values without being given known correlation values to the inputs ŝ 806. In some embodiments, the machine-learning architecture 800 can be a combination of machine-learning architectures. By way of example, a first network can use the input ŝ 806 and provide the output ŷ 820 as an input ŝML to a second machine-learned architecture, with the second machine-learned architecture providing a final output ŷf. In another embodiment, one or more machine-learning architectures can be implemented at various points throughout the training module 808.

In some machine-learned models, all layers of the model are fully connected. For example, all perceptrons in an MLP model act on every member of ŝ. For an MLP model with a 100×100 pixel image as the input, each perceptron provides weights/biases for 10,000 inputs. With a large, densely layered model, this may result in slower processing and/or issues with vanishing and/or exploding gradients. A CNN, which may not be a fully connected model, can process the same image using 5×5 tiled regions, requiring only 25 perceptrons with shared weights, giving much greater efficiency than the fully connected MLP model.

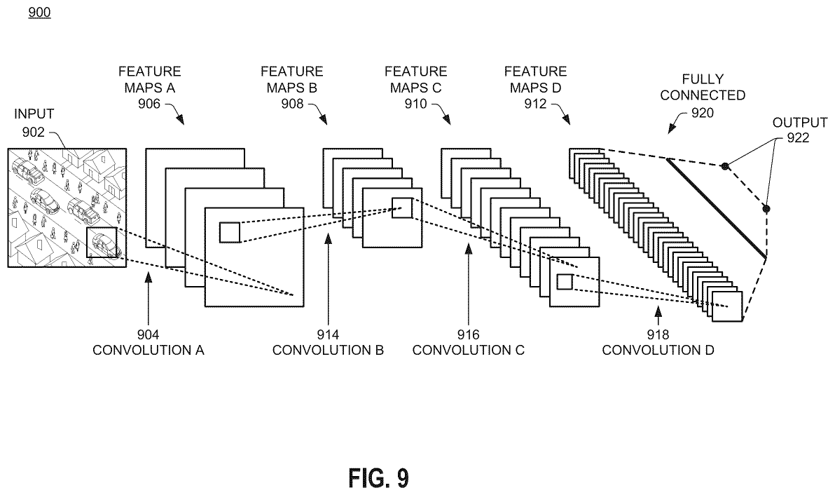

FIG. 9 represents some embodiments of an example model 900 using a CNN to process an input image 902, which includes representations of objects that can be identified via object recognition, such as people or cars (or a as described in relation to FIGS. 1-7). Convolution A 904 can be performed to create a first set of feature maps (e.g., feature maps A 906). A feature map can be a mapping of aspects of the input image 902 given by a filter element of the CNN. This process can be repeated using feature maps A 906 to generate further feature maps B 908, feature maps C 910, and feature maps D 912 using convolution B 914, convolution C 916, and convolution D 918, respectively. In this example, the feature maps D 912 become an input for fully connected network layers 920. In this way, the machine-learned model can be trained to recognize certain elements of the image, such as people, cars, etc., and provide an output 922 that, for example, identifies the recognized elements. In some embodiments, an inference generated with an ultrasound system can be appended to a feature map (e.g., feature map B 908) generated by a neural network (e.g., CNN). In this way, the feature vector and/or inference can be used as a secondary/conditional input to the neural network.

Although the example of FIG. 9 shows a CNN as a part of a fully connected network, other architectures are possible and this example should not be seen as limiting. There can be more or fewer layers in the CNN. A CNN component for a model can be placed in a different order, or the model can contain additional components or models. There may be no fully connected components, such as a fully convolutional network. Additional aspects of the CNN, such as pooling, downsampling, upsampling, or other aspects known to people skilled in the art can also be employed.

### An Example Device

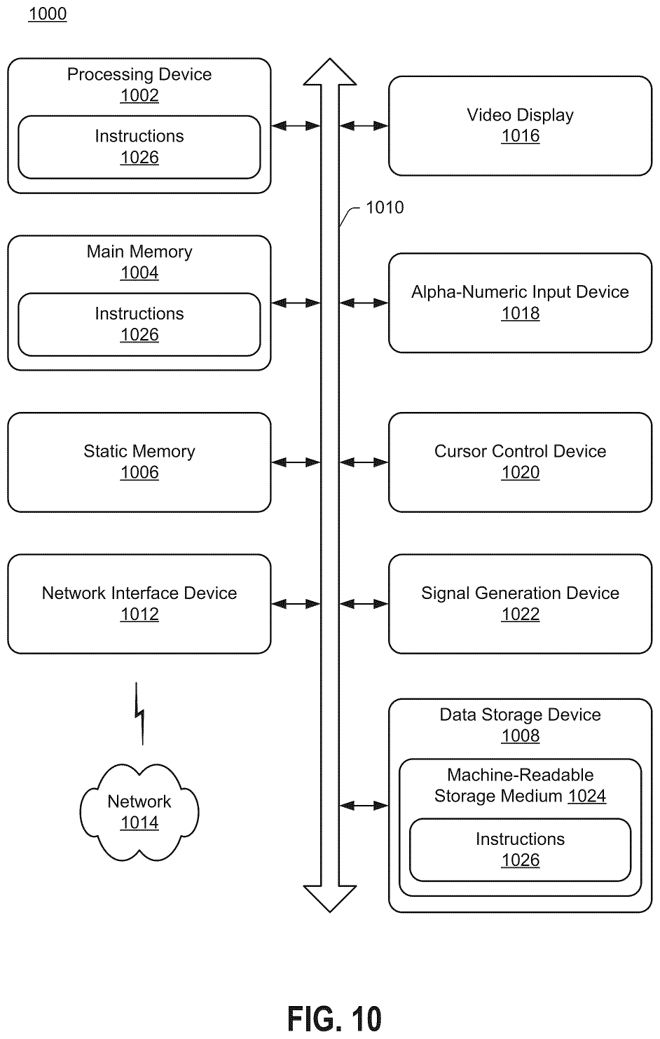

FIG. 10 illustrates a block diagram of some embodiments of a computing device 1000 that can perform one or more of the operations described herein. The computing device 1000 can be connected to other computing devices in a local area network (LAN), an intranet, an extranet, and/or the Internet. The computing device can operate in the capacity of a server machine in a client-server network environment or in the capacity of a client in a peer-to-peer network environment. The computing device can be provided by a personal computer (PC), a server computer, a desktop computer, a laptop computer, a tablet computer, a smartphone, an ultrasound machine, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein. In some embodiments, the computing device 1000 is one or more of an ultrasound machine, an ultrasound scanner, an access point, and a packet-forwarding component.

The example computing device 1000 can include a processing device 1002 (e.g., a general-purpose processor, a programmable logic device (PLD), etc.), a main memory 1004 (e.g., synchronous dynamic random-access memory (DRAM), read-only memory (ROM), etc.), and a static memory 1006 (e.g., flash memory, a data storage device 1008, etc.), which can communicate with each other via a bus 1010. The processing device 1002 can be provided by one or more general-purpose processing devices such as a microprocessor, a central processing unit, or the like. In some embodiments, the processing device 1002 comprises a complex instruction set computing (CISC) microprocessor, a reduced instruction set computing (RISC) microprocessor, a very long instruction word (VLIW) microprocessor, or a processor implementing other instruction sets or processors implementing a combination of instruction sets. The processing device 1002 can also comprise one or more special-purpose processing devices such as an application-specific integrated circuit (ASIC), a field programmable gate array (FPGA), a digital signal processor (DSP), a network processor, or the like. The processing device 1002 can be configured to execute the operations described herein, in accordance with one or more aspects of the present disclosure, for performing the operations and steps discussed herein.

The computing device 1000 can further include a network interface device 1012, which can communicate with a network 1014. The computing device 1000 also can include a video display unit 1016 (e.g., a liquid crystal display (LCD), an organic light-emitting diode (OLED), a cathode ray tube (CRT), etc.), an alphanumeric input device 1018 (e.g., a keyboard), a cursor control device 1020 (e.g., a mouse), and an acoustic signal generation device 1022 (e.g., a speaker, a microphone, etc.). In one embodiment, the video display unit 1016, the alphanumeric input device 1018, and the cursor control device 1020 can be combined into a single component or device (e.g., an LCD touch screen).

The data storage device 1008 can include a computer-readable storage medium 1024 on which can be stored one or more sets of instructions 1026 (e.g., instructions for carrying out the operations described herein, in accordance with one or more aspects of the present disclosure). The instructions 1026 can also reside, completely or at least partially, within the main memory 1004 and/or within the processing device 1002 during execution thereof by the computing device 1000, where the main memory 1004 and the processing device 1002 also constitute computer-readable media. The instructions can further be transmitted or received over the network 1014 via the network interface device 1012.

Various techniques are described in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. In some aspects, the modules described herein are embodied in the data storage device 1008 of the computing device 1000 as executable instructions or code. Although represented as software implementations, the described modules can be implemented as any form of a control application, software application, signal-processing and control module, hardware, or firmware installed on the computing device 1000.

While the computer-readable storage medium 1024 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that causes the machine to perform the methods described herein. The term “computer-readable storage medium” shall accordingly be taken to include, but not be limited to, solid-state memories, optical media, and magnetic media.

There are a number of example embodiments described herein.

Example 1 is an architecture to build a global machine learning (ML) model, the architecture comprising a platform to identify a group of clients to build a global model by federated learning, wherein the platform includes: a group manager to build the global model by supplying a model definition for the global model to the group and aggregating model parameters received from the group to build the global model, where the model parameters are generated by the clients training a local ML model at their respective client sites using local data at their respective client sites; and an incentive calculator communicably coupled to the group manager to calculate an incentive to each client communicably coupled to the platform based on said each client's contribution to train the global model, each client's contribution including one or more model parameters generated as a result of training their local ML model with local data.

Example 2 is the architecture of example 1 that may optionally include registries for storing a model format and feature format for the global model; and a server to provide the model format and feature format to the group as part of the model definition.

Example 3 is the architecture of example 2 that may optionally include that the server provides the model and feature format to the group as part of the model definition after the group manager sends a request for training to the clients and the clients join the group in response to the request for training.

Example 4 is the architecture of example 2 that may optionally include that the server provides the model format and feature format to said each client for use when training their local model.

Example 5 is the architecture of example 1 that may optionally include that the group manager is operable to aggregate the model parameters from the clients based on at least one of client data set size of data used to train their respective local model and their local model's accuracy.

Example 6 is the architecture of example 1 that may optionally include that the incentive calculator is operable to calculate the incentive based on an amount of each client's contribution.

Example 7 is the architecture of example 6 that may optionally include that each client's contribution is based on at least one of client data set size of data used to train their respective local model and their local model's accuracy.

Example 8 is the architecture of example 6 that may optionally include that the incentive calculator calculates the incentive based on stored training and trading histories.

Example 9 is the architecture of example 1 that may optionally include that the local model trained by the clients has identical feature sets.

Example 10 is the architecture of example 1 that may optionally include that the platform is operable to identify the group to build a global model in response to a request from one or more users of the global model.

Example 11 is the architecture of example 1 that may optionally include an inference service responsive to request for use of the global model by one or more users.

Example 12 is the architecture of example 11 that may optionally include that the inference service is operable to: receive an API request for use of the global model using feature data from a user received as part of the API request; and send, to the user, an inference generated by the global model based on the feature data.

Example 13 is the architecture of example 1 that may optionally include that the inference service is operable to: receive a request from a user to use the global model; and provide access to the global model for downloading by the user.

Example 14 is a method for building a global machine learning (ML) model, the method comprising: identifying a group of clients to build a global model by federated learning; supplying a model definition for the global model to the group; aggregating model parameters received from the group to build the global model, the model parameters being generated by the clients training a local ML model at their respective client sites using local data at their respective client sites; and calculating an incentive to each client communicably coupled to the platform based on said each client's contribution to train the global model, where each client's contribution includes one or more model parameters generated as a result of training their local ML model with local data.

Example 15 is the method of example 14 that may optionally include sending a request for training the global model to the clients of the group; receiving, from the clients and in response to the request for training, an indication that the clients want to join the group; storing registries that contain a model format and feature format for the global model; and sending the model format and feature format to clients in the group as part of the model definition for use by each of the clients in training their local model.

Example 16 is the method of example 14 that may optionally include aggregating the model parameters from the clients based on at least one of client data set size of data used to train their respective local model and their local model's accuracy.

Example 17 is the method of example 14 that may optionally include that calculating the incentive based on an amount of each client's contribution.

Example 18 is a non-transitory computer readable storage media having instructions stored thereupon that, when executed by a processor of a computing system, the instructions cause the computing system to perform operations for building a global machine learning (ML) model, the method comprising: identifying a group of clients to build a global model by federated learning; supplying a model definition for the global model to the group; aggregating model parameters received from the group to build the global model, the model parameters being generated by the clients training a local ML model at their respective client sites using local data at their respective client sites; and calculating an incentive to each client communicably coupled to the platform based on said each client's contribution to train the global model, each client's contribution including one or more model parameters generated as a result of training their local ML model with local data.

Example 19 is the non-transitory computer readable storage media of example 18 that may optionally include that the operations further comprise: sending a request for training the global model to the clients of the group; receiving, from the clients and in response to the request for training, an indication that the clients want to join the group; storing registries that contain a model format and feature format for the global model; sending the model format and feature format to clients in the group as part of the model definition for use by each of the clients in training their local model; and aggregating the model parameters from the clients based on at least one of client data set size of data used to train their respective local model and their local model's accuracy.

Example 20 is the non-transitory computer readable storage media of example 18 that may include that calculating the incentive is based on an amount of each client's contribution.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Whereas many alterations and modifications of the present disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the disclosure.

We claim:

1. An architecture to build a global machine learning (ML) model, the architecture comprising:
a platform to identify a group of clients to build a global model by federated learning, wherein the platform includes
a group manager to build the global model by supplying a model definition for the global model to the group and aggregating model parameters received from the group to build the global model, the model parameters being generated by the clients training a local ML model at their respective client sites using local data at their respective client sites; and
an incentive calculator communicably coupled to the group manager to calculate an incentive to each client communicably coupled to the platform based on said each client's contribution to train the global model, each client's contribution including one or more model parameters generated as a result of training their local ML model with local data.

2. The architecture of claim 1 further comprising:
registries for storing a model format and feature format for the global model; and
a server to provide the model format and feature format to the group as part of the model definition.

3. The architecture of claim 2 wherein the server provides the model and feature format to the group as part of the model definition after the group manager sends a request for training to the clients and the clients join the group in response to the request for training.

4. The architecture of claim 2 wherein the server provides the model format and feature format to said each client for use when training their local model.

5. The architecture of claim 1 wherein the group manager is operable to aggregate the model parameters from the clients based on at least one of client data set size of data used to train their respective local model and their local model's accuracy.

6. The architecture of claim 1 wherein the incentive calculator is operable to calculate the incentive based on an amount of each client's contribution.

7. The architecture of claim 6 wherein each client's contribution is based on at least one of client data set size of data used to train their respective local model and their local model's accuracy.

8. The architecture of claim 6 wherein the incentive calculator calculates the incentive based on stored training and trading histories.

9. The architecture of claim 1 wherein the local model trained by the clients has identical feature sets.

10. The architecture of claim 1 wherein the platform is operable to identify the group to build a global model in response to a request from one or more users of the global model.

11. The architecture of claim 1 further comprising an inference service responsive to request for use of the global model by one or more users.

12. The architecture of claim 1 wherein the inference service is operable to:
receive an API request for use of the global model using feature data from a user received as part of the API request; and
send, to the user, an inference generated by the global model based on the feature data.

13. The architecture of claim 1 wherein the inference service is operable to:
receive a request from a user to use the global model; and
provide access to the global model for downloading by the user.

14. A method for building a global machine learning (ML) model, the method comprising:
identifying a group of clients to build a global model by federated learning;
supplying a model definition for the global model to the group;
aggregating model parameters received from the group to build the global model, the model parameters being generated by the clients training a local ML model at their respective client sites using local data at their respective client sites; and
calculating an incentive to each client communicably coupled to the platform based on said each client's contribution to train the global model, each client's contribution including one or more model parameters generated as a result of training their local ML model with local data.

15. The method of claim 14 further comprising:
sending a request for training the global model to the clients of the group;
receiving, from the clients and in response to the request for training, an indication that the clients want to join the group;
storing registries that contain a model format and feature format for the global model; and
sending the model format and feature format to clients in the group as part of the model definition for use by each of the clients in training their local model.

16. The method of claim 14 further comprising aggregating the model parameters from the clients based on at least one of client data set size of data used to train their respective local model and their local model's accuracy.

17. The method of claim 14 wherein calculating the incentive is based on an amount of each client's contribution.

18. A non-transitory computer readable storage media having instructions stored thereupon that, when executed by a processor of a computing system, the instructions cause the computing system to perform operations for building a global machine learning (ML) model, the method comprising:
identifying a group of clients to build a global model by federated learning;
supplying a model definition for the global model to the group;
aggregating model parameters received from the group to build the global model, the model parameters being generated by the clients training a local ML model at their respective client sites using local data at their respective client sites; and
calculating an incentive to each client communicably coupled to the platform based on said each client's contribution to train the global model, each client's contribution including one or more model parameters generated as a result of training their local ML model with local data.

19. The non-transitory computer readable storage media of claim 18 wherein the operations further comprise:
sending a request for training the global model to the clients of the group;
receiving, from the clients and in response to the request for training, an indication that the clients want to join the group;
storing registries that contain a model format and feature format for the global model;
sending the model format and feature format to clients in the group as part of the model definition for use by each of the clients in training their local model; and
aggregating the model parameters from the clients based on at least one of client data set size of data used to train their respective local model and their local model's accuracy.

20. The non-transitory computer readable storage media of claim 18 wherein calculating the incentive is based on an amount of each client's contribution.
